(19) United States
(12) Patent Application Publication
(10) Pub. No.: US 2017/0172078 A1
(43) Pub. Date: Jun. 22, 2017

(54) REMOTE CONTROLLED ELECTRICALLY INDEPENDENT IRRIGATION SYSTEM

(71) Applicants: Norma Alicia Gonzalez Hernandez, Chihuahua (MX); Mario Erik Torres Gutierrez, Chihuahua (MX); Juan Antonio Chavez Murga, Chihuahua (MX); Hussein Maloof Flores, Chihuahua (MX)

(72) Inventors: Norma Alicia Gonzalez Hernandez, Chihuahua (MX); Mario Erik Torres Gutierrez, Chihuahua (MX); Juan Antonio Chavez Murga, Chihuahua (MX); Hussein Maloof Flores, Chihuahua (MX)

(21) Appl. No.: 14/995,287

(22) Filed: Jan. 14, 2016

(30) Foreign Application Priority Data
Dec. 18, 2015 (MX) MX/A/2015/017297

(51) Int. Cl. A01G 25/16; H04W 4/00; G05B 15/02

(52) U.S. Cl. CPC A01G 25/16; G05B 15/02; H04W 4/008

(57) ABSTRACT

The present invention refers to a remote controlled electrical independent irrigation system that takes advantage of the irrigation water flow to generate, store, and use the electrical energy produced by a turbine to keep electrified its electronic irrigation controller that enables or disables the system through wireless devices.

### OBJECT OF THE INVENTION

The present invention refers to a remote controlled electrical independent irrigation system that takes advantage of the water irrigation flow to generate, store, and use the electrical energy produced by a turbine, which is part of the system, to keep electrified its electronic irrigation controller that enables or disables the system through wireless devices.

### BACKGROUND

There are technologies oriented to the automation of the irrigation systems and a market that provides a multitude of commercial systems with various available benefits. Today, there are still introduced improvements especially those focused on an application area of continuous renewal such as communications. The systems in which the remote stations to control the irrigation are connected to central control via cables, are being replaced with wireless systems.

There are also irrigation systems that are installed in large surfaces and in which during the irrigation process enable the measurement of pH of the Earth, relative humidity, temperature, coupled with the fertilization application. To perform all these tasks, it is essential to have measurement and control equipment through the length and width of the irrigation area, this equipment by its nature requires electrical power for its operation, so installation of solar cells, wind systems, or an electric distribution network is highly costly.

In order to have an energy source that will help to maintain in operation a measuring system and the irrigation control in a continuous and efficient manner, the present invention presents a way to obtain electrical power that allows feeding to a remote control irrigation system of irrigation with a wireless network, taking advantage of the pressure and the water kinetic energy of the irrigation system to feed power to the control station by a hydraulic turbine, supported by a required local energy storage system by at least one battery.

The following patent documents were found in the subject matter of the present invention:

The U.S. Pat. No. 8,225,810 B2 describes several implementations of a device, system, and method to control the irrigation of an area. A realization, an apparatus includes at least one sensor module which is configured to detect the moisture content of the soil in an irrigation area. The sensor module is also configured to determine a rate of the moisture change of the soil based on the detected soil moisture content. The device also includes a central control module that is configured to run an irrigation event for an irrigation area if the detected soil moisture content reaches a threshold lower moisture content. The central control module is also configured to complete the irrigation event if the detected soil moisture content reaches a moisture content exceeding the threshold.

The U.S. Pat. No. 8,185,248 is an implementation of an irrigation control system that includes a transmitter with a controller unit and has a connector to be attached to an irrigation controller that has activation output connectors from the station. The controller is configured to receive an indication that the irrigation controller enabled an irrigation station, and is also configured so the transmission unit transfers a wireless signal in response to the indication. A receiver unit is coupled to an actuator in a device that can be operated, such as an irrigation valve; the actuator is configured to trigger the irrigation valve to control the water flow. The receiving unit receives the wireless activation signal and in response, makes the actuator operate the device.

The U.S. Pat. No. 8,340,828 provides a monitoring system of the growth conditions of the plants in the proximity of the roots. In addition, provides a system that applied the analysis in real-time of the growth process parameters and takes into account components, such as plants, soil, climate, fertilizers, and water. A management system based on the analysis in real-time that is designed to calculate the amount of water and fertilizer necessary every day for the plants.

The United States Patent Application No. 2014/0039697 presents a system to be used in irrigation control, including: a configured irrigation controller to connect with one or more valves on a site and to control the activation and deactivation of one or more valves in accordance with a stored program on the irrigation controller; a wireless adapter coupled directly through a cable connection directly with the irrigation controller; and a network adapter connected wirelessly through a communication path point by point with the wireless adapter, in which the network adapter is configured for more couples through an internet connection with a local router configured to provide communication through a network distributed to a remote control server; that the wireless adapter is configured to test the irrigation controller to acquire local status information and the wireless adapter is configured to communicate, through the wireless channel point-to-point, the status information to the server.

The United States Patent Application No. 2014/0039698 refers to an irrigation control device of which has a data modulator over an alternate potency signal by the distortion of amplitude of a first front portion of selected cycles of the alternate potency signal, and effectively allows a total amplitude of the alternate potency signal in the next portion of the selected cycle, in which the first front portion and the following portions are either both on the high side of a cycle or both on one low side of a cycle of the alternate potency signal. The irrigation control device additionally includes a configured interface to connect the modulator to a multi-threaded interface coupled to a plurality of irrigation devices to allow the alternate potency signal that applies to the interface multi-wire.

The United States Patent Application No. 2015/0230417 refers to the methods and devices that are provided to automatically determine the water needs of the plants and adjust the irrigation. In an implementation, the method includes: receiving from a user through a user interface of an irrigation control unit and at the moment after an initial commercial sale, a region identifier corresponding to a region of the irrigation controller; the identification of a set of historical values of a plurality of sets of values pre-stored in the irrigation control unit memory; receive a current value of at least another environmental variable from at least one sensor; receive at least one historical value of the identified set of historical values of the memory; determination of water requirements of the plants using at least one historical value and the current value; releasing an adjustment control message to the irrigation controller; and adjust the implementation of the irrigation program, the irrigation program defined a maximum irrigation period.

The United States Patent Application No. 2015/0105921 A1 refers to a system and method for a wireless irrigation control using a remote application. The system includes a processor and a plurality of hotspots with switches for connection in at least one irrigation device. A non-volatile memory is coupled to the processor and equipped with executable instructions by the processor for the function of each interactive zone switch to be directed. There is at least a remote control application to establish a program within the non-volatile memory for operation of each switch of the interactive zone and receive the programming of non-volatile memory in response to a user that wishes to review or modify the schedule. A wireless network component is connected to the processor and the non-volatile memory and is in communication with at least one remote application to schedule the operation of at least one switch of the interactive zone and at least one irrigation device.

The United States Patent Application No. 2013/0110293 A1 presents a device and method to remotely control the water spray systems. Computing devices, such as smart phones, personal computers, and similar, may be connected to the internet and programs for the control of water spraying systems. A controller can be provided that communicates with the computing device and activates and deactivates the solenoids inside an existing irrigation system. The remote computing device is used to set the scheduling irrigation parameters, etc. and communicate wirelessly to the controller. The controller can also have access to the internet for the local weather reports and enable or disable the irrigation based on these reports.

The United States Patent Application No. 2013/0297082 A1 presents several implementations that provide wireless irrigation control devices and related methods. In an embodiment, an irrigation control system includes a transmitter unit that includes a controller and a connector to be attached to an irrigation controller that has activation output connectors of the station. The controller may receive an indication that the irrigation controller has activated a watering station, and can send a wireless activation signal in response to the indication. A receiver unit is connected to an actuator adapted to an actionable device, such as an irrigation valve, the actuator is configured to trigger the irrigation valve and control the water flow at the same time. The receiving unit receives the wireless activation signal and in response, made the actuator operate the device. In some embodiments, the receiving unit includes a circuit capacitor and battery charge to feed the receiving unit and control an engagable solenoid.

The U.S. Pat. No. 8,930,032 B2 provides a system and method for controlling a wireless irrigation with a remote application. The system includes a processor and plurality of interactive zone switches to connect at least one irrigation system; each zone also has an operable switch and in addition allows to detect the status of a connected irrigation device. The non-volatile memory is connected to the processor and provided with executable instructions for the direct operation of each interactive zone switch. There is at least a remote control application to establish a program within the non-volatile memory for each interactive zone switch and receive the programming of non-volatile memory in response to a user that wishes to review or modify the program schedule. A wireless network component is connected to the processor and the non-volatile memory is in communication with the remote application to schedule the operation of at least one interactive zone switch and at least one irrigation system.

The U.S. Pat. No. 4,629,904 presents a small scale hydroelectric generator that has a micro-hydro axial flow turbine mounted at a lower end of the loading tube, preferably the siphon type, through which are diverted the water from an admission container. The turbine includes a stator section formed with an axial core that provides an annular passage path that has an exit end in the vicinity of a rotor of a section adjacent to the coaxial rotor. The rotor blades have a length equal to the internal radius of the path. A plurality of fins are arranged in an expanding circle between the stator section and the rotor. A float mechanism is located in the admission container that follows the water level and controls the extended positions of the flaps reducing the water flow through the output tube in a predetermined relationship with the water level. The annular duct has fixed vanes that direct the water flow in a helical whirlwind movement to impact on the blades that are prepared to receive the current in an optimal angle of 90°. The generator is within a distance of the turbine with a closed hydraulic system comprising a variable displacement pump and impulse by a turbine and a hydraulic motor located in the driving and the generator. The pump has a flow control that actuates the motor at a constant RPM in all acceptable load conditions in the generator.

The U.S. Pat. No. 5,040,945 shows a hydraulic turbine which is constructed mainly from plastic and uses water to lubricate the joints that support the gear. The invention provides a turbine that is lightweight for an easy installation, of low cost, and requires virtually no maintenance. The invention is very suitable to activate an electric turbine for micro-hydro applications.

The United States Patent Application No. 2012/0207588 provides a self-contained generator that converts the gravitational potential energy of the water into electricity, while it continually replenishes the water in the container. The portable generator Hydro Electric is independent, the electrical Hydro generator has a micro turbine fueled by gravity. The water is provided from an elevated tank and the flow pressure through the intake channel, through a series of reduced diameter pipes, since the water is approaching the turbine.

The United States Patent Application No. 2002/0021008 A1: The system allows areas such as golf courses that are constantly pressurized by means of irrigation systems, to generate electricity in remote areas from the golf course. This system includes an impulse turbine, such as a Pelton wheel, in combination with an electric valve operated from a distance, and signalization of the turn on and turn off through the use of a motherboard to run the turbine under demand.

How it was summarized in previous patents, which have one or more similar characteristics to the proposed invention, however none of them allows the generation and storage of electrical energy of taking advantage of the pressure and kinetic energy of the water of the irrigation system to feed the remote control station using a hydraulic turbine, supported by a local storage system of the required energy by using batteries obtaining, also locally, this energy, thus allowing for the operation of an electrically autonomous irrigation control system which is activated or deactivated by means of wireless devices.

### BRIEF DESCRIPTION OF THE FIGURES

FIG. 1 is a schematic diagram of an electrical autonomous irrigation control system controlled at distance according to the present invention comprising:

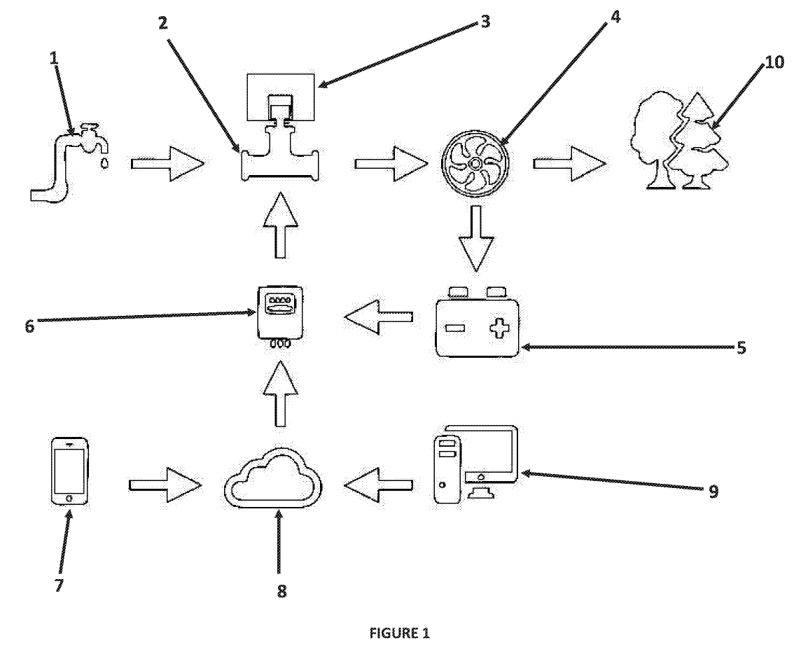

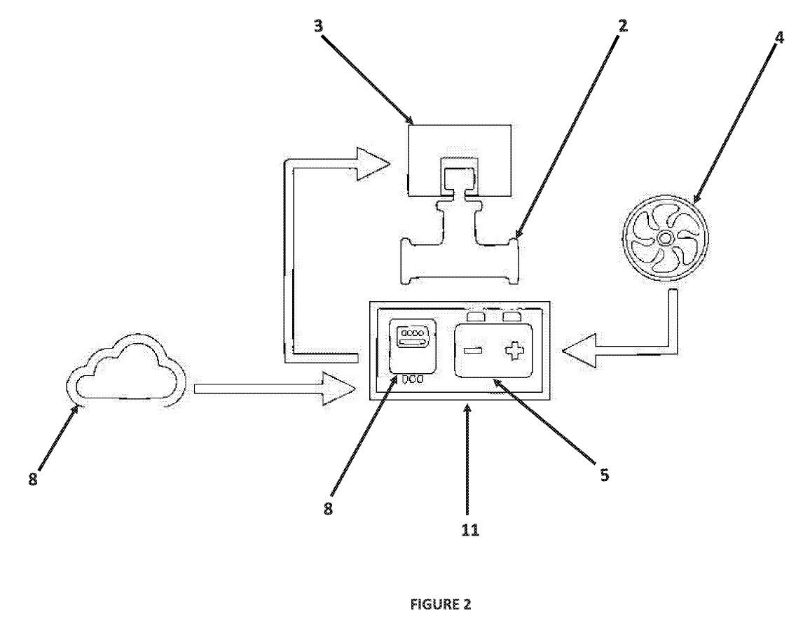

Water intake (1).

Valve (2).

Electronic actuator (3) connected to the valve for controlling the operation of the same.

Turbine generator of direct electric current (4) by means of the water flow.

At least one battery (5) adapted to store the energy that produces the turbine (4) and the ability to energize and make functional both the electronic controller (6) and an electronic actuator (3).

Electronic irrigation controller (EIC) (6), formed by a board that integrates the inputs and the outputs for different applications, but necessarily connected to the network or internet (8) wirelessly.

Mobile devices (7) for the remote control of the EIC (6), which include cell phones, tablets, laptops, and any device with the ability to connect to a wireless network. Wireless network or the internet (8).

Server (9) form by a CPU, a keyboard, and a monitor, that can connect wired or wireless to the EIC (6).

irrigation area (10).

weatherproof cabinet including the battery (5) and the EIC (6).

FIG. 2 shows a schematic diagram showing the cabinet (11) with at least one battery (5) and the EIC (6) to integrate the system in the shortest possible space.

### DETAILED DESCRIPTION OF THE INVENTION

The system of the present invention, to its optimum performance, includes the following elements and connections:

A water intake (1), which is connected by a pipe to a valve (2) which is activated by an actuator (3) that is connected to the valve. The valve is connected through a pipeline to an electric power generating turbine (4), which is located in contact by means of electrical cables to at least one battery (5). The battery is connected to an electronic irrigation controller (EIC) (6) and to the actuator (3) previously mentioned for the opening and closing of the valve (2) by means of electrical cables. The EIC (6) is connected to a wireless network or to an internet signal (8), which in turn, connects to the mobile devices which inform and control certain variables of the user, as well as to a server which is feeding data and instructions for the operation of the system (9), and with this, obtain acceptable irrigation levels, and their respective control (10). An output pipe connected to the electrical power generating turbine (4) moves towards the irrigation area (10).

### HOW IT WORKS

The present invention provides the electronic irrigation control for different applications by using electronic devices. Considering a water flow obtained from the water intake (1), the water passes through a valve (2), for immediately after, flow through the blades of a turbine (4) that generates direct electrical energy and with this, take advantage of the pressure of the water that is used for irrigation (10).

The direct electric energy produced by the turbine (4) is stored in at least one battery (5) and with this, activates or disables the electronic irrigation controller (EIC (6) when it is necessary.

An electronic device connected to a wireless network or the internet (8) with the ability to enable or disable the actuator (3) which is located on the valve (2), to remotely open and close using a mobile (7) also connected wirelessly. A server (9) is also wirelessly connected (8) to the EIC (6), to set and control the irrigation cycles, obtain measurements, information, and other data relevant to the user. The valve (2) may also be manually activated when desired by the user.

To integrate the system into the best possible system, both the battery (5) and the EIC (6) are placed in a weatherproof cabinet (11).

1. A remote controlled electrical independent irrigation system comprising:
a water intake (1) connected by a pipe to a valve (2) the valve is triggered by an actuator (3) which is connected to the valve, the valve is connected through a pipeline to an electric power turbine generator (4), the electric power turbine generator is connected via electric cables to the at least one battery (5); each battery is connected to an electronic irrigation controller (EIC) (6) and to the actuator (3) for opening and closing of the valve (2) by the electric cables; the electronic irrigation controller EIC (6) is connected to a wireless network or internet (8), which connects to a mobile device which informs and controls variables to a user, and to a server (9) which is fed with data and instructions for an operation of the system.

2. The remote controlled electrical independent irrigation system according to claim 1, wherein the water passes through the valve (2) flows through blades of the electric power turbine generator (4), generating direct electricity.

3. The remote controlled electrical independent irrigation system according to claim 2, wherein the direct electricity produced by the electric power turbine generator (4) is stored in the at least one battery (5) and is used to activate or disabled the electronic irrigation controller (EIC) (6) when it is necessary.

4. The remote controlled electrical independent irrigation system according to claim 1, further including an electronic device connected to the wireless network or the internet (8), the electronic device enables or disables the actuator (3) to remotely open and close using the mobile device (7) which is also connected wirelessly.

5. The remote controlled electrical independent irrigation system according to claim 1, wherein, the server (9) is connected via wireless or internet (8) to the electronic irrigation controller EIC (6), the server (9) sets and controls irrigation cycles, obtains measurements, information, and data relevant to the user.

6. The remote controlled electrical independent irrigation system according to claim 1, wherein the valve (2) is manually operated.

7. The remote controlled electrical independent irrigation system according to claim 1, wherein the battery (5) and the electronic irrigation controller EIC (6) are encased inside a weatherproof enclosure (11).
